(19) United States
(12) Patent Application Publication
(10) Pub. No.: US 2012/0195550 A1
(43) Pub. Date: Aug. 2, 2012

(54) METHOD OF MAKING OPTICAL MICROSTRUCTURE PATTERN ON LIGHT GUIDE PLATE, LIGHT GUIDE PLATE THEREOF AND IMPRINTING MOLD

(75) Inventor: Jiun-Hau IE, Taoyuan (TW)

(73) Assignee: GLOBAL LIGHTING TECHNOLOGY INC., Taoyuan (TW)

(21) Appl. No.: 13/195,021

(22) Filed: Aug. 1, 2011

(30) Foreign Application Priority Data
Jan. 31, 2011 (TW) 100103673
Jan. 31, 2011 (TW) 100103675
Jan. 31, 2011 (TW) 100103680

(51) Int. Cl. G02B 6/26; B23K 26/38

(52) U.S. Cl. 385/31; 219/121.69

(57) ABSTRACT

The present invention discloses a method of making an optical microstructure patterns on a light guide plate, a light guide plate thereof and a imprinting mold. The method of making the optical microstructure patterns on the light guide plate includes a step of bombarding the surface of a substrate to form a micro notch thereon by laser, in which the periphery of the micro notch has as at least a protrusion, and a step of bombarding the protrusion to at least downsize the protrusion by another laser.

### RELATED APPLICATIONS

This application claims priority to Taiwan Application Serial Number 100103673, filed Jan. 31, 2011, Taiwan Application Serial Number 100103675, filed Jan. 31, 2011 and Taiwan Application Serial Number 100103680, filed Jan. 31, 2011, which are herein incorporated by reference.

### BACKGROUND

1. Technical Field

The present invention relates to a method of making a light guide plate, more particular to a method of making an optical microstructure pattern on a light guide plate.

2. Description of Related Art

Conventionally, when making an optical microstructure on a surface of a light guide unit, one of the methods is to utilize laser beams (called laser hereinafter) to in sequence bombard a surface of a substrate (e.g. the light guide unit itself or an imprinting mold), such that the surface of the substrate are formed with a plurality of micro notches through being melted via the laser, so as to directly make optical microstructures on the surface of the light guide unit, or with the micro notches formed on the surface of the substrate, optical microstructures can be correspondingly imprinted on the surface of the light guide unit.

However, utilizing the laser to irradiate the surface of the substrate would inevitably generate the so called “molten slag splashing phenomenon”, thus, each micro notch may be formed with a crater profile, i.e. the periphery of the micro notch is formed with one protrusion or a plurality of protrusions.

As such, no matter utilizing the laser to directly make optical microstructures on a surface of a substrate or utilizing the micro notches to indirectly imprint corresponding optical microstructures on the surface of the substrate, the protrusions at the periphery of the micro notch would fall into the micro notch and fill in the micro notch when the protrusions are bended or collapsed. Thus the light guiding performance of the light guide unit may be decayed.

Moreover, because of the molten slag splashing phenomenon, the protrusions may be formed with reverse-hook shapes, so when the light guide unit is installed in a display device, and stacked with other optical films, the protrusions of the light guide unit is unbeneficial for being tightly adhered with the optical films, so the light output efficiency is decreased, or the protrusions of the light guide unit may scratch or pierce the optical films.

Based on what is disclosed above, the mentioned method of making optical microstructures still have some disadvantages and inconveniences, the skilled people in the arts have been searching for solutions for solving such problems, but a proper solution or means is yet to be seen.

As such, how to effectively eliminate the molten slag splashing phenomenon at the micro notch for avoiding the mentioned disadvantages is a serious issue which shall be improved.

### SUMMARY

The present invention discloses a method of making an optical microstructure pattern on a light guide plate, for providing an optical microstructure pattern on a light guide plate.

The present invention discloses a method of making an optical microstructure pattern on a light guide plate, so as to downsize, or even smash (remove), a crater profile formed at each micro notch in the same stage that the micro notch is generated.

The present invention discloses a method of making an optical microstructure pattern on a light guide plate, for reducing or eliminating the possibilities of the protrusions at the periphery of a micro notch filling in the micro notch due to falling off, and the light guiding performance of the light guide plate is therefore decayed.

The present invention discloses a method of making an optical microstructure pattern on a light guide plate, for reducing or eliminating the possibilities of the light guide plate damaging optical film stacked therewith in a display device.

The present invention discloses a method of making an optical microstructure pattern on a light guide plate, including a step of utilizing a first laser to bombard the surface of a substrate to form a micro notch on the surface of the substrate, wherein the periphery of the micro notch is formed with at least one protrusions, and another step of utilizing at least one second laser to bombard the protrusions for downsizing the dimensions of the protrusions.

As what is mentioned above, the method of making an optical microstructure pattern on a light guide plate provided by the present invention does not need additional processing means to smash and eliminate the crater profile at each micro notch, so the processing cost and expenditure for acquiring the processing equipment are saved. Moreover, the light guiding performance of the light guide plate can be prevented from deterioration after being made.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart showing the method of making an optical microstructure pattern on a light guide plate according to the present invention.

FIG. 2 is a detail flow chart showing Step (101) of FIG. 1, according to one embodiment of the present invention.

FIG. 3 is a schematic view showing the operation of Step (101) of FIG. 1.

FIG. 4 shows a top view (a) and a cross sectional view (b) of one crater profile formed at each micro notch.

FIG. 5A is a detail flow chart showing Step (102) of FIG. 1, according to one embodiment of the present invention.

FIG. 5B is a detail flow chart showing Step (102) of FIG. 1, according to another embodiment of the present invention.

FIG. 6 is a schematic view showing the operation of Step (102) of FIG. 1.

FIG. 7 is a cross sectional views (a) (b) (c) showing a plurality of types of micro notches after being processed with Step (102) of FIG. 1.

FIG. 8A is a detail flow chart showing one alternative of Step (102) of FIG. 1.

FIG. 8B is top view showing the protrusions of each micro notch after being bombarded.

FIG. 9A is a detail flow chart showing Step (102) of FIG. 1, according to one another embodiment of the present invention.

FIG. 9B is another top view showing the protrusions of each micro notch after being bombarded.

FIG. 10 is schematic view showing another operation of Step (102) of FIG. 1.

FIG. 11 is a schematic appearance view of a light guide plate.

FIG. 12 is a top view showing one micro notch in a zone M of the optical microstructure pattern of the light guide plate according to one embodiment of the present invention.

FIG. 13 is a cross sectional view taken alone line 13-13 of FIG. 12.

FIG. 14 is a top view showing one micro notch in a zone M of the optical microstructure pattern of the light guide plate according to another embodiment of the present invention.

FIG. 15 is a cross sectional view taken alone line 15-15 of FIG. 14.

FIG. 16 is a top view showing one micro notch in a zone M of the optical microstructure pattern of the light guide plate according to still one another embodiment of the present invention.

FIG. 17 is a top view showing one micro notch in a zone M of the optical microstructure pattern of the light guide plate according to still one another embodiment of the present invention.

FIG. 18 is a schematic view showing the display device according to one embodiment of the present invention.

FIG. 19A is a schematic view showing the operation of one alterative of the imprinting mold for printing an optical microstructure pattern.

FIG. 19B is a schematic view showing the operation of another alterative of the imprinting mold for printing an optical microstructure pattern.

FIG. 20A is a subsequent flow chart showing the method of making an optical microstructure pattern on a light guide, according to still one another embodiment of the present invention.

FIG. 20B is a subsequent flow chart showing the method of making an optical microstructure pattern on a light guide, according to still one another embodiment of the present invention.

FIG. 21 is a top view showing one micro notch in a zone M of the micro hole concentrated pattern of the imprinting mold according to one embodiment of the present invention.

FIG. 22 is a cross sectional view taken alone line 22-22 of FIG. 21.

FIG. 23 is a top view showing one micro notch in a zone M of the micro hole concentrated pattern of the imprinting mold according to another embodiment of the present invention.

FIG. 24 is a cross sectional view taken alone line 24-24 of FIG. 23.

FIG. 25 is a top view showing one micro notch in a zone M of the micro hole concentrated pattern of the imprinting mold according to still one another embodiment of the present invention.

FIG. 26 is a top view showing one micro notch in a zone M of the micro hole concentrated pattern of the imprinting mold according to still one another embodiment of the present invention.

FIG. 27 is a schematic view showing the appearance and the operation of the imprinting mold according to one embodiment of the present invention.

FIG. 28 is a schematic view showing the imprinting mold being utilized to print optical microstructure patterns on a light guide plate 501 according to one embodiment of the present invention, also showing a partially enlarged view of one of the protrusion member.

FIG. 29 is a schematic view showing the appearance and the operation of the imprinting mold according to another embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

As what is mentioned above, utilizing laser beams (called laser hereinafter) to irradiate and penetrate through a surface of a substrate would inevitably generate the molten slag splashing phenomenon, thus, each micro notch may thereby formed with a crater profile, protrusions at the periphery of the crater may fall into the micro notch, and the light guiding performance of a light guide unit is therefore decayed. The present invention utilizes the laser used to form the micro notch to downsize or eliminate the crater profile at each micro notch at the same stage when the micro notch is formed.

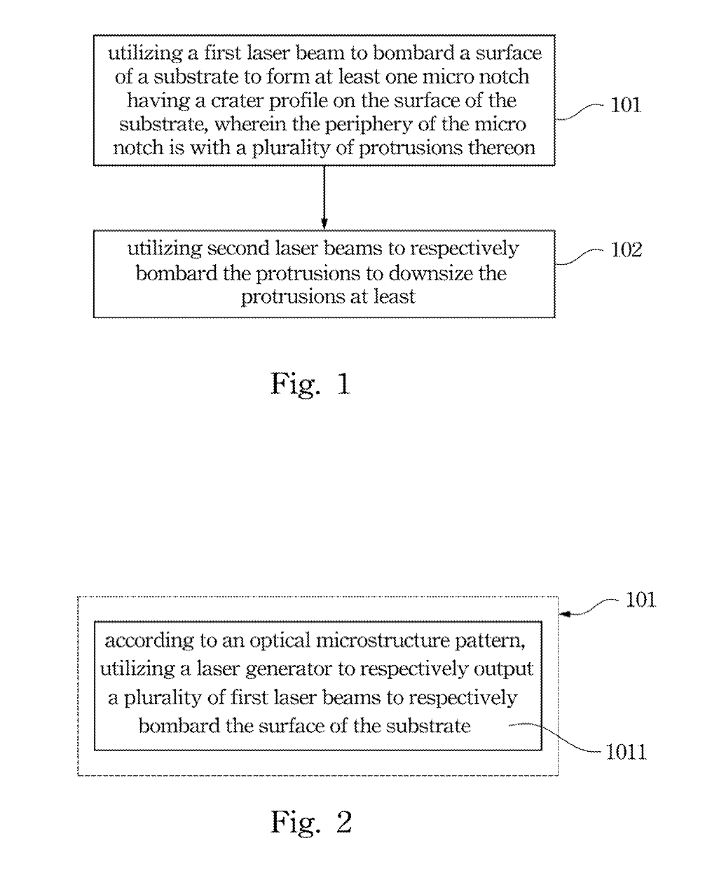

Referring to FIG. 1, which is a flow chart showing the method of making an optical microstructure pattern on a light guide plate according to the present invention.

The method of making an optical microstructure pattern on a light guide plate at least includes the following steps:

Step (101): utilizing a first laser beam (called first laser hereinafter) to bombard (e.g. irradiate and penetrate) a surface of a substrate to form at least one micro notch having a crater profile on the surface of the substrate, wherein the periphery of the micro notch has one protrusion or a plurality of protrusions (using plural protrusions for illustration hereinafter); and

Step (102): utilizing one or a plurality of second laser beams (called second laser hereinafter) to bombard the protrusions to downsize the protrusions or to completely remove the protrusions.

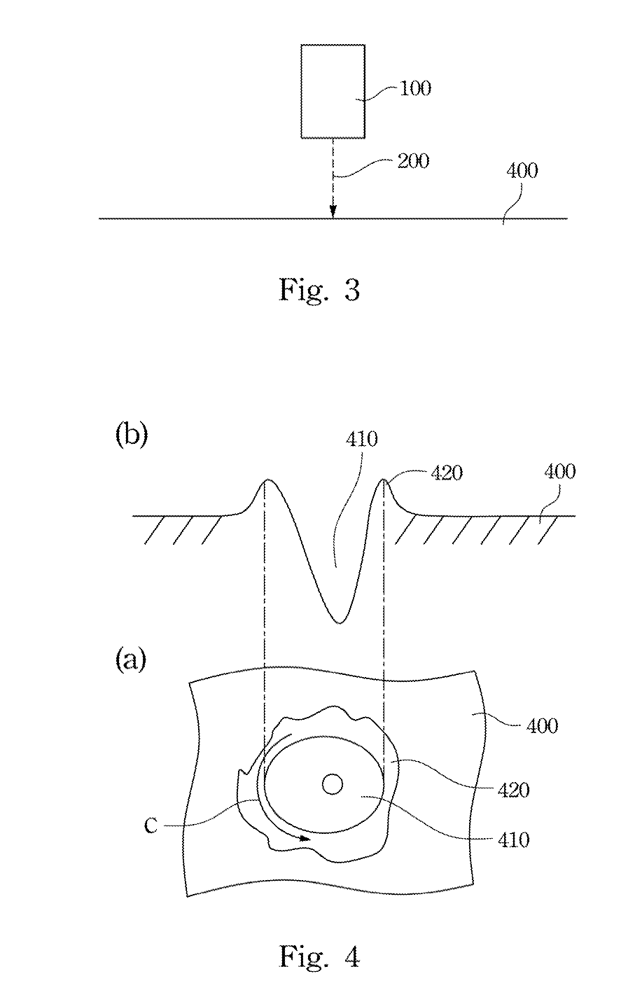

Referring from FIG. 2 to FIG. 4, wherein FIG. 2 is a detail flow chart showing Step (101) of FIG. 1, according to one embodiment of the present invention; FIG. 3 is a schematic view showing the operation of Step (101) of FIG. 1; and FIG. 4 shows a top view (a) and a cross sectional view (b) of the crater profile formed at each micro notch.

According to one embodiment of the present invention, Step (101) further includes the following detail steps:

Step (1011): according to an optical microstructure pattern containing a plurality of optical microstructures, and according to a plurality of pre-determined (preset in advanced) coordinates, a laser generator 100 respectively outputs a plurality of first laser 200 to the surface of a substrate 400, such that the first laser 200 respectively bombards the surface of the substrate 400 so as to form a plurality of micro notches 410 through melting, and the periphery of each micro notch 410 has one or a plurality of protrusions 420. Because the dimensions of the notches are in the micrometer level, so as to be called as micro notches 410.

What shall be addressed is that because of the mentioned molten slag splashing phenomenon, the crater profile formed on each micro notch 410 is not able to be completely the same. Most of the protrusions 420 may be arranged to surround the periphery of the micro notch 410, or may be formed outside the mentioned surrounding range. The dimensions of the protrusions 420 are not the same, and the protrusions 420 are arranged at the periphery of the micro notch 410 in a non-continuous manner, or can be at least one annular protrusion 420. As such, the micro notch 410 shown in FIG. 4 is only for illustration to one of micro notches 410, and does not mean that all crater profiles formed on those micro notches 410 are all similar to the one shown in FIG. 4.

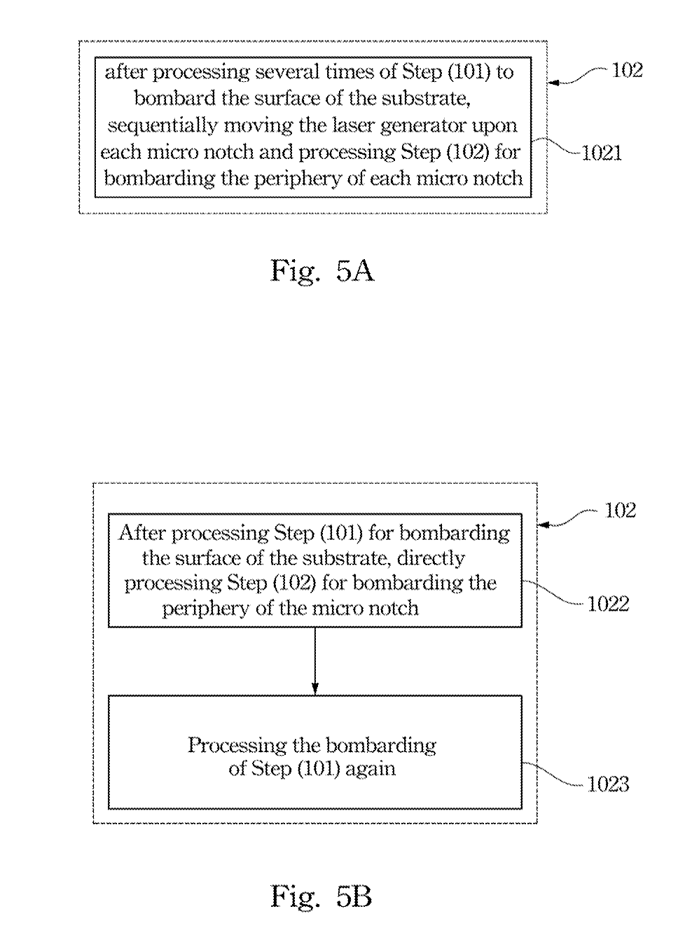

Referring to FIG. 5A, which is a detail flow chart showing Step (102) of FIG. 1, according to one embodiment of the present invention.

According to one embodiment of the present invention, Step (102) further includes the following detail step:

Step (1021): utilizing the first laser 200 to bombard the surface of the substrate 400 for several times (Step (101)) to distribute a plurality of micro notches 410 on the surface of the substrate 400, then in sequence moving to each micro notch 410 and utilizing the second laser to respectively bombard the periphery of each micro notch 400 (Step (102)).

On the other hand, referring to FIG. 5B, which is a detail flow chart showing Step (102) of FIG. 1, according to another embodiment of the present invention.

According to the embodiment of the present invention, Step (102) further includes the following detail steps:

Step (1022): at every operation of utilizing the first laser 200 to bombard the surface of the substrate 400 to form one micro notch 410 on the surface of the substrate 400 (Step (101)), then the periphery of the micro notch 410 is directly processed with the bombarding of Step (102); and

Step (1023): processing one time of utilizing the first laser 200 to bombard the surface of the substrate 400 to form another micro notch 410 on the surface of the substrate 400 (Step (101)), then back to Step (1022) for another circle of bombarding.

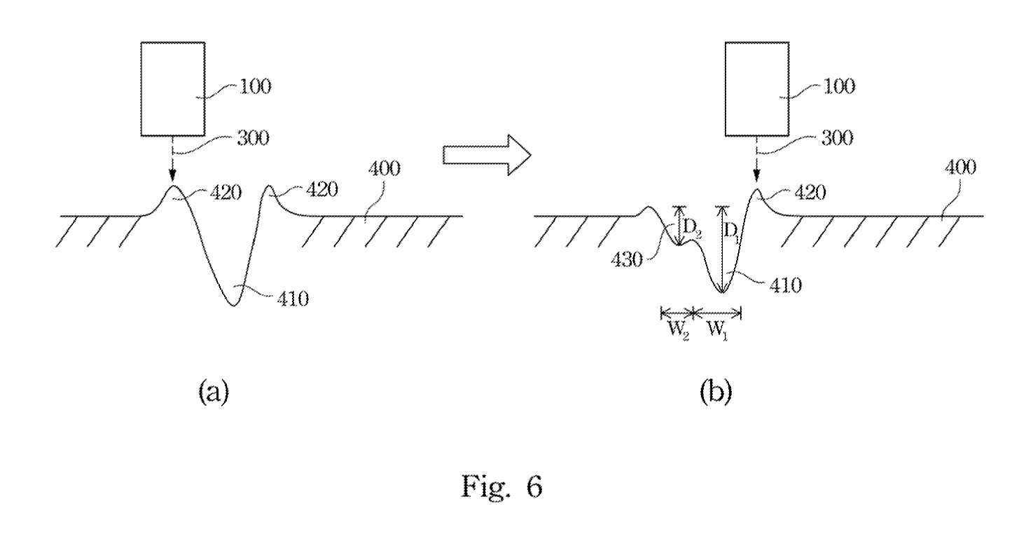

Referring to FIG. 6, which is a schematic view showing the operation of Step (102) of FIG. 1.

According to the mentioned embodiments, no matter Step (1021) or Step (1022) is processed, through the laser generator 100 respectively outputting one or more second laser 300 to the surface of the substrate 400 corresponding to the periphery of each micro notch 410, Step (102) can destroy the protrusions 420 randomly distributed at the periphery of each micro notch 410 according to a pre-determined path.

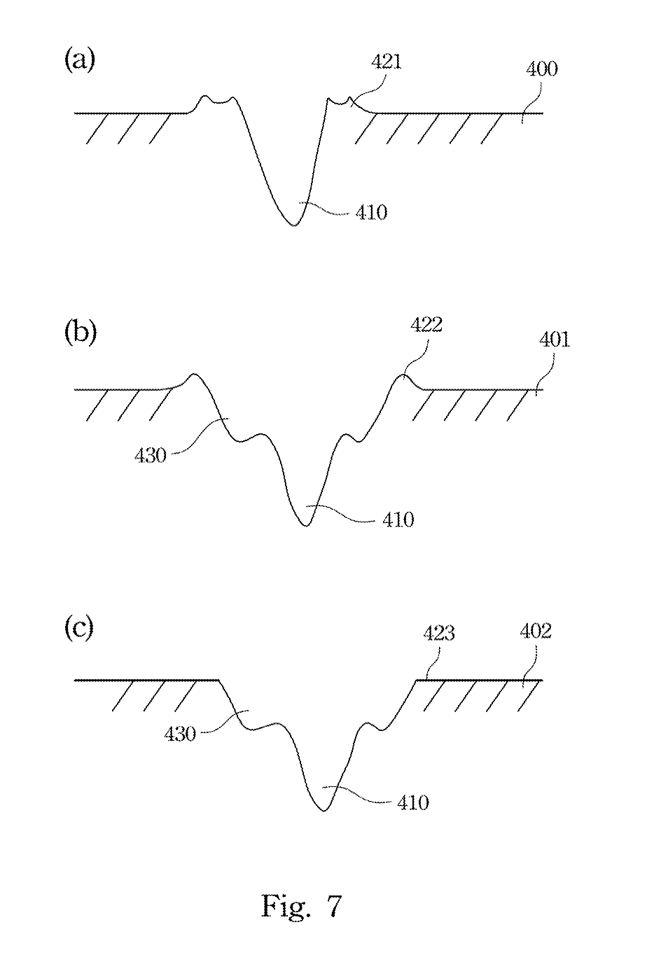

Referring to FIG. 7, which is a cross sectional view showing a plurality of types of micro notches 410 after being processed with Step (102) of FIG. 1.

When the second laser 300 bombards the protrusions 420, the protrusions 420 are broken and collapsed on the surface of the substrate 400, protrusions 421 having a downsized dimension may be formed (as shown in FIG. 7(a)), so the original height can no longer be maintained. Moreover, the tops of the protrusions 421 all have burned marks (e.g. yellow or black in color but not shown in figures) generated due to the bombarding of the second laser 300. The degree of burned marks is gradually changed from dark to light from the peripheries of the micro notches 410 toward a direction away from the micro notches 410.

Or, after the protrusions 420 are broken, the substrate 401 is formed with a plurality of concave portions 430 (as shown in FIG. 7 (b)) recessed toward the substrate 401 at the locations corresponding to the protrusions 420, the concave portions 430 (including the outer surfaces and inner surfaces) all have the burned marks (e.g. yellow or black in color but not shown) due to the bombarding of the second laser 300. Substantially, the degree of burned marks is gradually changed from dark to light from the peripheries of the micro notches 410 (including the concave portions 430) toward a direction away from the micro notches 410. Moreover, the outer ends of the concave portions 430 may still have tiny protrusions 422.

Or, with a proper adjustment, the outer ends of the concave portions 430 generated through the second laser 300 bombarding the substrate 402 may not have the crater profiles, and formed with a plane part 423 (as shown in FIG. 7 (c)) substantially aligned with the surface of the substrate 402.

As such, once the protrusions 420 can no longer maintain the height thereof or the height does not exist, the probabilities of the protrusions 420 falling into the micro notch 410 due to being bended or collapsed are reduced, thus the light guiding performance of light guide unit is prevented from deterioration, and the mentioned optical film is protected from being scratched or pierced.

What shall be addressed is that when the second laser 300 bombards the protrusions 420, through adjusting the output parameter of the laser generator 100, the downsized protrusions 420, the concave portions 430 or the concave portions 430 with no crater profile can be obtained.

The appearances and dimensions of the downsized protrusions 420, the concave portions 430 and the concave portions 430 with no crater profiles are not able to be completely the same, as such, the peripheries of the micro notches 410 shown in FIG. 7 (a), (b), (c) are only served as examples, and the actual appearance of the peripheries of all micro notches 410 are not limited to what are shown in FIG. 7 (a), (b), (c).

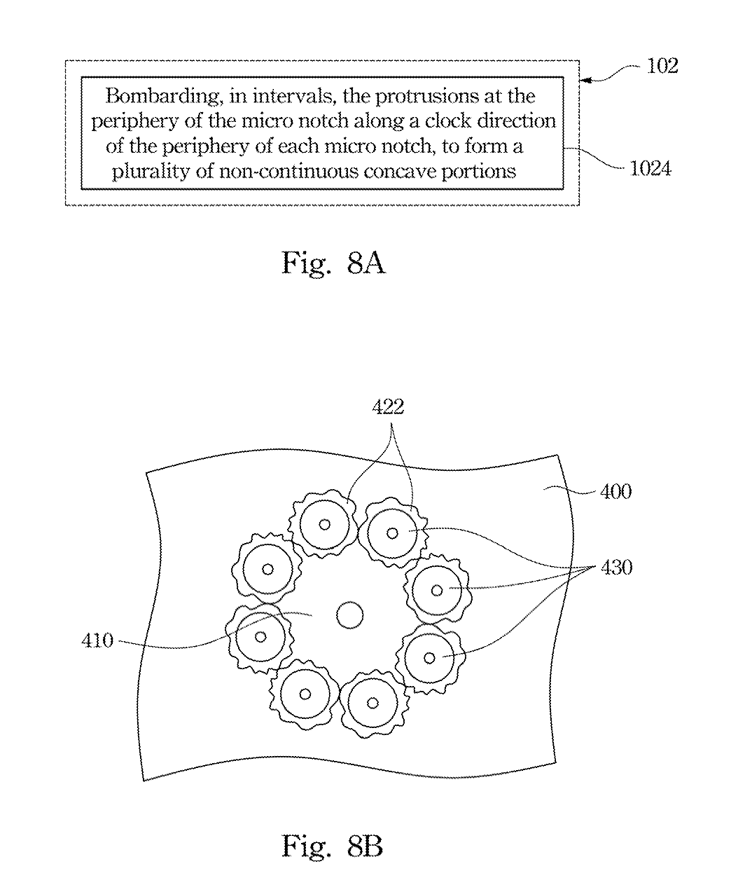

More substantially, referring to FIG. 8A and FIG. 8B, wherein FIG. 8A is a detail flow chart showing one alternative of Step (102) of FIG. 1; and FIG. 8B is top view showing the protrusions 420 of each micro notch 410 after being bombarded.

FIG. 8A discloses one of the detail alternatives of Step (102), the detail step is as following:

Step (1024): moving the laser generator 100 along the periphery of each micro notch 410 in a clock direction C (referring to FIG. 4, e.g. the clockwise or counterclockwise direction), and utilizing the second laser 300 to bombard the protrusions 420 at the periphery of the micro notch 410 for smashing the protrusions 420 and forming a plurality of non-continuous concave portions 430, wherein the concave portions 430 surround the micro notch 410, and the depth D2 of each concave portion 430 is smaller than the depth D1 of the micro notch 410 (referring to FIG. 6(b)), and the maximum width W2 of each concave portion 430 is smaller than the maximum width W1 of the micro notch 410 (referring to FIG. 6(b)).

What shall be addressed is that each concave portion 430 is generated through the second laser 300, so the width of each concave portion 430, the distance there between or the depth D2 recessing toward the substrate 400 are not able to be completely the same. As such, the concave portions 430 shown in FIG. 8B are served as examples, and the contours of the concave portions 430 at the peripheries of all micro notches 410 are not limited to what are shown in FIG. 8B.

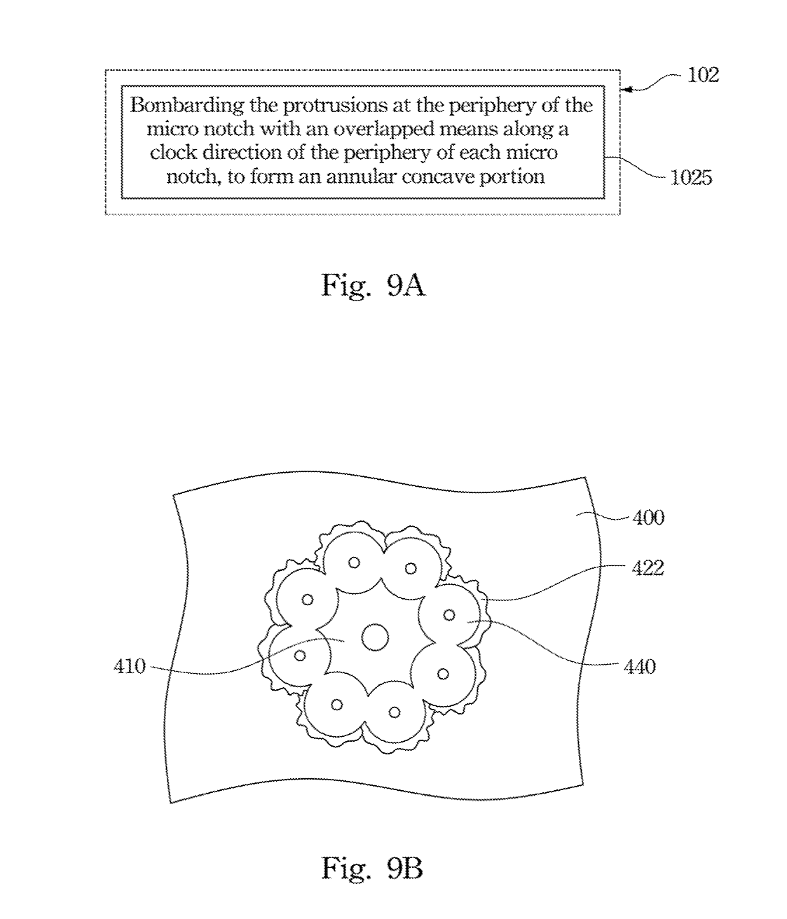

Referring to FIG. 9A and FIG. 9B, wherein FIG. 9A is another detail flow chart showing another alternative of Step (102) of FIG. 1; and FIG. 9B is another top view showing the protrusions 420 of each micro notch 410 after being bombarded.

FIG. 9A discloses one of the detail alternatives of Step (102), the detail step is as following:

Step (1025): moving the laser generator 100 along the periphery of each micro notch 410 in a clock direction C (referring to FIG. 4, e.g. the clockwise or counterclockwise direction), and utilizing the second laser to bombard. the periphery of the micro notch 410 in an overlapped means for smashing the protrusions 420, and an annular concave portion 440 recessed toward the substrate 400 is formed at a location corresponding to the periphery of the micro notch 410, wherein the annular concave portion 440 surrounds the micro notch 410, and the depth D2 of the annular concave portion 440 is smaller than the depth D1 of the micro notch 410.

What shall be addressed is that the annular concave portion 440 is generated through the second laser 300, so the dimension of the annular concave portion 440, or the depth D2 recessing toward the substrate 400 are not able to be completely the same. As such, the annular concave portion 440 shown in FIG. 9B is served as examples, and the contour of the annular concave portion 440 at the peripheries of all micro notches 410 is not limited to what are shown in FIG. 9B.

However, compared to the means of outputting the second laser 300 to the surface of the substrate 400 corresponding to the periphery of each micro notch 410 according to the pre-determined path, this invention does not exclude target each protrusion 420 and individually bombard the protrusions 420 at the periphery of each micro notch 410.

According to the mentioned embodiment, when Step (101) and Step (102) are processed, the substantial operation principles are as followings:

Principle I: adjusting the output parameter of the laser generator 100, so the power of each first last beam 200 is substantially the same as the power of each second laser 300, but the pulse number of the first laser 200 is greater than that of the second laser 300. For example, if the output power of the laser generator 100 is from zero to the maximum, so called 0%˜100%, the power of each second laser 300 and each first laser 200 are 80% of the maximum output power of the laser generator 100. Moreover, the pulse number of each first laser 200 is 25, and the pulse number of each second laser 300 is 10.

Principle II: adjusting the output parameter of the laser generator 100, so the power of each first last beam 200 is greater than the power of each second laser 300. For example, if the output power of the laser generator 100 is from zero to the maximum, so called 0%˜100%, the power of the first laser is 90% of the maximum output power of the laser generator 100, the pulse number thereof is 25; the power of the second laser is 80% of the maximum output power of the laser generator 100, the pulse number thereof is 5. Take another example for illustration, the power of each second laser 300 can only be 1% to 30% of the power of each first laser 200.

Moreover, when the power of each first laser 200 is greater than the power of each second laser 300, the pulse number of the first laser 200 is not limited to be the same as the pulse number of the second laser 300, and can be different from the pulse number of the second laser 300, or:

Principle III: adjusting the output parameter of the laser generator 100, so the power of each first last beam 200 is smaller than the power of each second laser 300, and the pulse number of the first laser 200 is greater than that of the second laser 300. For example, if the output power of the laser generator 100 is from zero to the maximum, so called 0%˜100%, the power of the first laser is 70% of the maximum output power of the laser generator 100, the pulse number thereof is 25; the power of the second laser is 90% of the maximum output power of the laser generator 100, the pulse number thereof is 5. Take another example for illustration, the power of the first laser 200 can only be 30% to 80% of the power of the second laser 300.

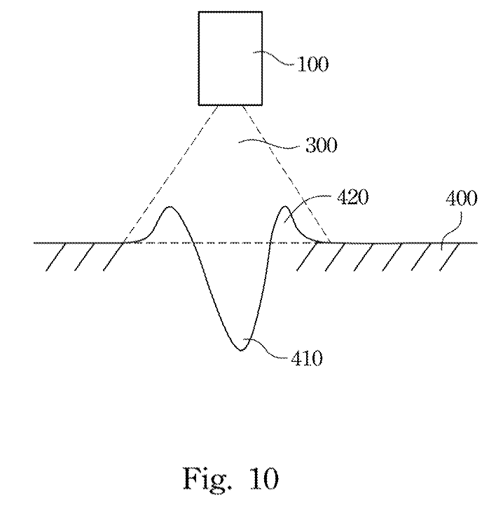

What shall be addressed is that when emitting a laser to a substrate for forming a notch, the power level is relevant to the width of the notch, the pulse number is relevant to the depth of the notch. Referring to FIG. 10, which is schematic view showing another operation of Step (102) of FIG. 1. As such, no matter the periphery of each micro notch 410 has one or a plurality of protrusions 420, when Step (102) is processed and the principle III is adopted, the detail step is as followings:

With respect to the coordinates of a micro notch 410 formed through bombarding the surface of the substrate 400 with the first laser 200, the second laser 300 aims at the center of the micro notch 410 and bombard the micro notch 410, such that the protrusions 420 are broken to form an annular concave portion 440 (referring to FIG. 9B). The annular concave portion 440 surrounds the micro notch 410, and the depth of the annular concave portion 440 is smaller than that of the micro notch 410, so the width of the micro notch 410 is enlarged through the annular concave portion 440.

Because the power of the second laser 300 is greater than that of the first laser 200, the bombarding range of the second laser 300 can reach the protrusions 420 at the periphery of the micro notch 410, when the micro notch 410 is bombarded by single second laser 300, the protrusion(s) 420 at the periphery of the micro notch 410 can be formed to downsized protrusion(s) 421 (as shown in FIG. 7(a)); or an annular concave portion 440 (referring to FIG. 9B) can be formed at the periphery of the micro notch 410; or with the proper adjustment, the outer end of the annular concave portion 440 formed through the second laser 300 bombarding the substrate 402 has no crater profile, the plane part 423 shown in FIG. 7(c) is therefore obtained.

Moreover, when the principle III is adopted and the second laser 300 is utilized to directly bombard the micro notch 410, not only the object of enlarging the width of the micro notch 410 can be achieved, also the protrusions 420 at the periphery of the micro notch 410 can be downsized by a single bombarding, so the preparation cost and time for using the laser equipment can be saved.

According to one embodiment of the present invention, the mentioned substrates 400˜402 can be a light guide plate 500, the micro notches 410 are arranged to the mentioned optical microstructure pattern P, and distributed on the surface of the light guide plate 500, e.g. the light incident surface or light output surface of the light guide plate 500.

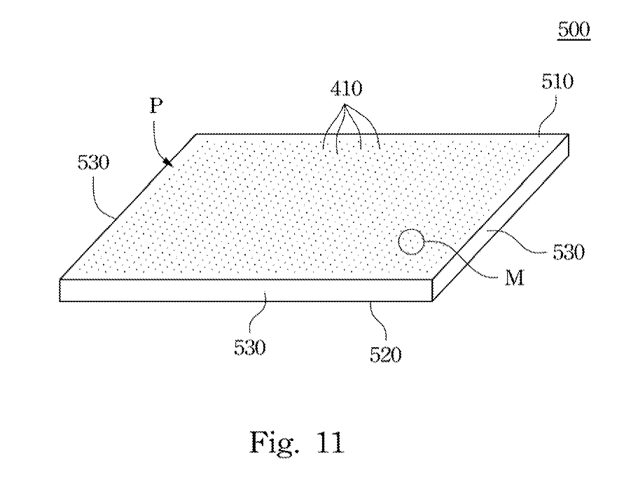

Referring to FIG. 11, which is a schematic appearance view of a light guide plate 500.

According to the present invention, the light guide plate 500 includes a plate member 501 and an optical microstructure pattern P. The optical microstructure pattern P is distributed on the surface of the plate member 501, and is formed on the surface of the plate member 501 through being directly processed by laser.

In this embodiment, the plate member 500 is in a rectangular shape, and has a first surface 510 and an opposite second surface 520, and four third surfaces 530 surrounding and connecting with the first surface 510 and the second surface 520. The third surfaces 530 can be defined as the surfaces which can be referred as the thickness of the plate member 501, and the area of any of the third surfaces 530 is smaller than that of the first surface 510 and the second surface 520. Generally speaking, the first surface 510 and the second surface 520 of the plate member 501 are designed as a light output surface, and one of the third surfaces 530 of the plate member 501 can be designed as a light incident surface. The optical microstructure pattern P is not limited to be disposed on the light incident surface, the light output surface or both of the light incident surface and the light output surface of the plate member 501.

The shape (e.g. sheet-like shaped or curved shape) of the light guide plate 500 can be designed and selected with considerations of the thickness thereof, the hardness thereof or the material. The material of the light guide plate 500 can be a transparent material such as polyethylene Terephthalate (PET), polycarbonate (PC)or Poly (methyl methacrylate) (PMMA).

Moreover, the shape (e.g. sheet-like shaped or curved shape) of the light guide plate 500 can be selected and determined with considerations of the thickness thereof and the hardness thereof.

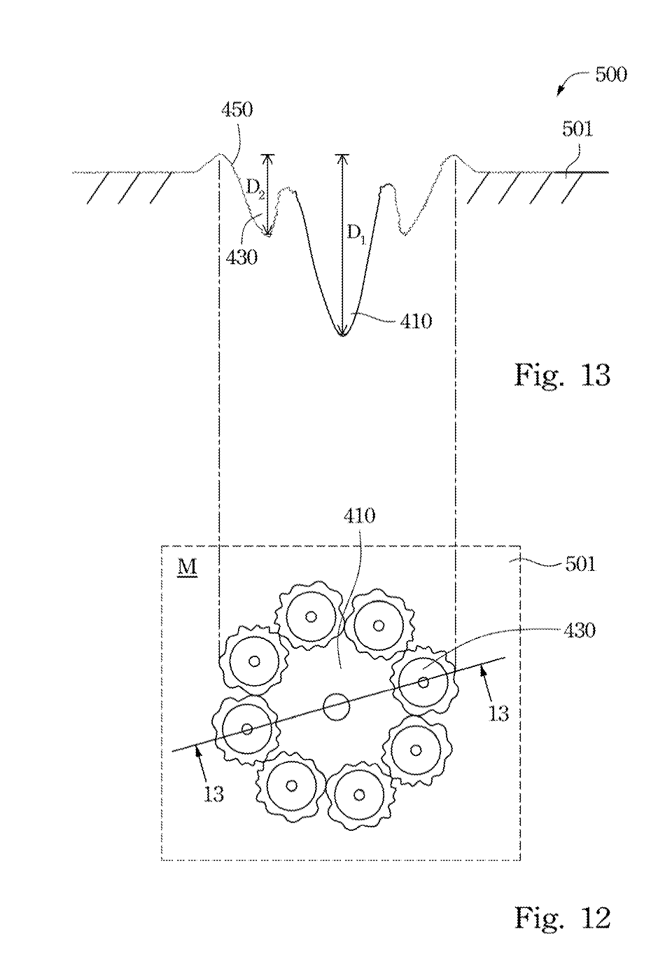

Referring to FIG. 12 and FIG. 13, wherein FIG. 12 is a top view showing one micro notch 410 in a zone M of the optical microstructure pattern P of the light guide plate 500 according to one embodiment of the present invention; and FIG. 13 is a cross sectional view taken alone line 13-13 of FIG. 12.

The optical microstructure pattern P is composed of a plurality of micro notches 410 (i.e. optical microstructures) being arranged (as shown in FIG. 11). The periphery of each micro notch 410 is distributed with one or a plurality of concave portions 430 recessed toward the plate member 501 (as shown in FIG. 12), one or a plurality of downsized protrusions 421 (which will be illustrated hereinafter) or distributed with both.

As such, each protrusion 420 of the craters has been downsized or smashed (removed), the original height thereof can no longer be maintained, the probabilities of the residual protrusions falling into the micro notch 410 due to being bended or collapsed are greatly reduced, thus the light guiding performance of the light guide plate 500 is prevented from deterioration.

According to the abovementioned, the concave portions 430 are also formed through being melted by laser 300 (as shown in FIG. 13), so the surfaces of each concave portion 430 (including the inner surface and outer surface) all have molten surfaces 450 formed through the laser 300, and the depth D2 of each concave portion 430 is smaller than the depth D2 of the micro notch 410, and the width of each concave portion 430 is smaller than the width of the micro notch 410 (as shown in FIG. 13). Of course, the width of each concave portion 430 can be larger than the width of the micro notch 410. The mentioned molten surface 450 is formed with burned marks (e.g. yellow or black in color). Substantially, the degree of burned marks is gradually changed from dark to light from the peripheries of the micro notches 410 (including the concave portions 430) toward a direction away from the micro notches 410. In other words, the molten surface 450 is gradually changed from dark to light in a ripple fashion from the periphery of the micro notch 410 (including the concave portions 430) toward a direction away from the micro notches 410.

The arrangement means of the optical microstructures is not limited by the present invention, e.g. being uniformly or non-uniformly arranged, or being arranged in an array means or being linearly arranged. The research and development personnel can choose or adjust the arrangement means of the optical microstructures according to actual needs.

The present invention further provides more embodiments for disclosing detail changes of the periphery of each micro structure 410.

Referring to FIG. 6, FIG. 12 and FIG. 13, according to one embodiment of the present invention, when the protrusions 420 of the crater are bombarded, the laser generator 100 moves along a clock direction (e.g. the clockwise direction or counterclockwise direction) of the periphery of each micro notch 410, and the laser 300 are utilized to bombard the protrusions 420 at the periphery of the micro notch 410, so a plurality of non-continuous concave portions 430 are formed. The concave portions 430 are arranged separately at the periphery of the micro notch 410 and together surround the micro notch 410, and the concave portions 430 are not in communication with each other. Moreover, in this embodiment, the interiors of the concave portions 430 can be arranged to not be in communication with the micro notch 410 (as shown in FIG. 13), or can be arranged to be all in communication with the micro notch 410.

What shall be addressed is that each concave portion 430 is formed through the bombarding of the laser 300, so the width of each concave portion 430, the distance there between, and the depth D2 recessing toward the plate member 501 are not able to be completely the same. So the concave portions 430 shown in FIG. 12 and FIG. 13 are served as examples, and the contours of the concave portions 430 at the peripheries of all micro notches 410 are not limited to what are shown in FIG. 12 and FIG. 13.

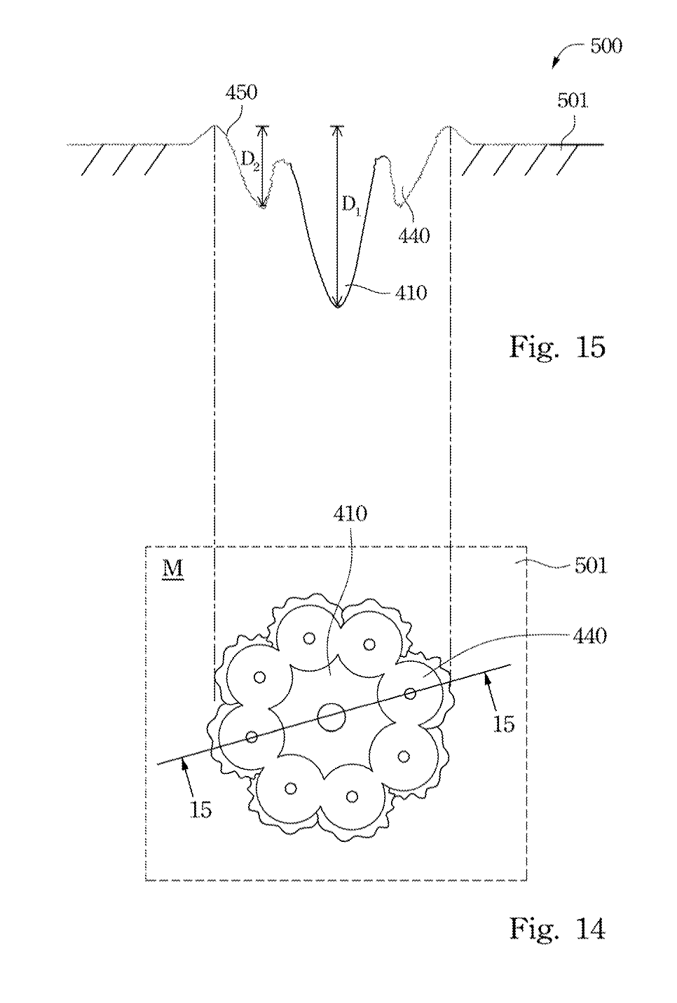

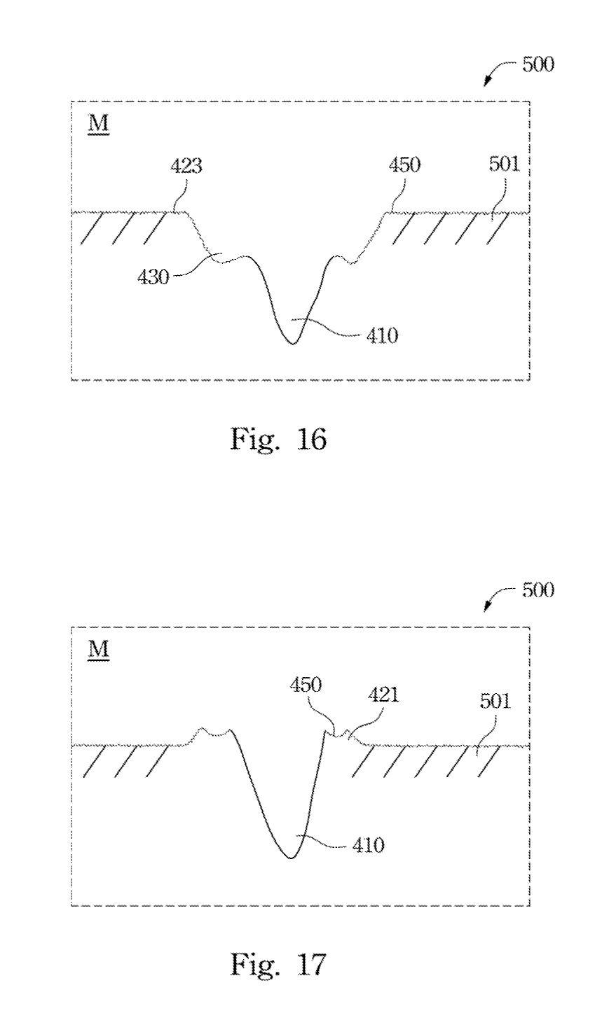

Referring to FIG. 6, FIG. 14 and FIG. 15, wherein FIG. 14 is a top view showing one micro notch 410 in a zone M of the optical microstructure pattern P of the light guide plate 500 according to another embodiment of the present invention; and FIG. 15 is a cross sectional view taken alone line 15-15 of FIG. 14.

According to the another embodiment of the present invention, when the protrusions 420 of the craters are bombarded (as shown in FIG. 6), the laser generator 100 utilizes the laser 300 to bombard each micro notch 410 and smash the protrusions 420 at the periphery of the micro notch 410, thus an annular concave portion 440 recessed toward the plate member 501 is formed at a location corresponding to the periphery of the micro notch 410, wherein the annular concave portion 440 surrounds the micro notch 410, and the depth D2 of the annular concave portion 440 is smaller than the depth D1 of the micro notch 410. Moreover, in this embodiment, the interiors of the concave portions can be arranged to not be in communication with the micro notch 410, or can be arranged to be all in communication with the micro notch 410 (as shown in FIG. 15).

What shall be addressed is that the annular concave portion 440 is formed through the bombarding of the laser 300, so the dimension of the annular concave portion 440, or the depth D2 recessing toward the plate member 501 are not able to be completely the same. As such, the annular concave portion 440 shown in FIG. 14 and FIG. 15 is served as examples, and the contour of the annular concave portion 440 at the peripheries of all micro notches 410 are not limited to what are shown in FIG. 14 and FIG. 15.

After each concave portion 430 (or annular concave portion 440) at the periphery of each micro notch 410 of the light guide plate 500 is formed, there may be dusts, particles or debris remained on the light guide plate 500, so when the interiors of the concave portions 430 (or the annular concave portion 440) are not in communication with the micro notch 410, each concave portion 430 (or the annular concave portion 440) can assist to collect the dusts, particles or debris for lowering the probabilities of falling into each micro notch 410.

What shall be addressed is that because the concave portion 430 (or the annular concave portion 440) is shallower than the micro notch 410, the function of guiding light is not provided, so even being filled with the dusts, particles or debris, the optical performance of the light guide plate 500 is not affected.

Because each concave portion 430 (or the annular concave portion 440) is formed through the bombarding of the laser 300, the mentioned molten slag splashing phenomenon would inevitably happen, however, the bombarding degree of the laser 300 used to bombard the protrusions 420 is much less than the bombarding degree of the laser used for generating the micro notch 410, so the crater profile is less obvious than the crater profile at each micro notch 410. As such, the mentioned disadvantages and inconvenience of the conventional arts are avoided.

Referring to FIG. 6 and FIG. 17, wherein FIG. 17 is a top view showing one micro notch 410 in a zone M of the optical microstructure pattern P of the light guide plate 500 according to still one another embodiment of the present invention.

According to the still one another embodiment of the present invention, when the protrusions 420 at the crater are bombarded (as shown in FIG. 6), through properly adjusting the parameter of the laser generator 100 (e.g. pulses of small power or small frequency), when the laser generator 100 enables the laser 300 to bombard each protrusion 420 at the periphery of the micro notch 410, the outer end of the concave portion 430 is prevented from forming the crater profile, i.e. the location where the surface of the plate member 501 being connected to the outer end of the concave portion 430 is formed with a plane part 423 substantially aligned with the surface of the plate member 501.

Because each micro notch 410 no longer has the crater profile, the situation that the protrusions 420 (as shown in FIG. 4) being bended or collapsed to fall into the micro notch 410 can be avoided, so the probabilities of the light guiding performance of the light guide plate 500 being decayed is reduced.

Referring to FIG. 6 and FIG. 17, wherein FIG. 17 is a top view showing one micro notch 410 in a zone M of the optical microstructure pattern P of the light guide plate 500 according to still one another embodiment of the present invention.

According to the still one another embodiment of the present invention, when the protrusions 420 at the crater are bombarded (as shown in FIG. 6), through properly adjusting the parameter of the laser generator 100 (e.g. pulses of small power or small frequency), when the laser generator 100 enables the laser 300 to bombard each protrusion 420 at the periphery of the micro notch 410, and after the protrusions 420 are broken and collapsed on the surface of the plate member 501, only downsized protrusions 421 (as shown in FIG. 17) are formed, instead of the concave portions. The tops of the protrusions 421 all have molten surfaces 450 formed through being bombarded by laser. The molten surfaces 450 are e.g. burned marks (e.g. yellow or block in color). The degree of burned marks is gradually changed from dark to light from the peripheries of the micro notches 410 toward a direction away from the micro notches 410.

As such, the residual protrusions 421 can no longer maintain the height thereof, the probabilities of the protrusions 421 falling into the micro notch 410 due to being bended or collapsed are reduced, thus the light guiding performance of light guide plate 500 is prevented from deterioration.

What shall be addressed is that the downsized protrusions 421 are formed through the bombarding of the laser, so the dimension and the contour of the downsized protrusions 421 are not able to be completely the same. As such, the downsized protrusions 421 shown in FIG. 17 are served as examples, and the contours of all the downsized protrusions 421 are not limited to what are shown in FIG. 17.

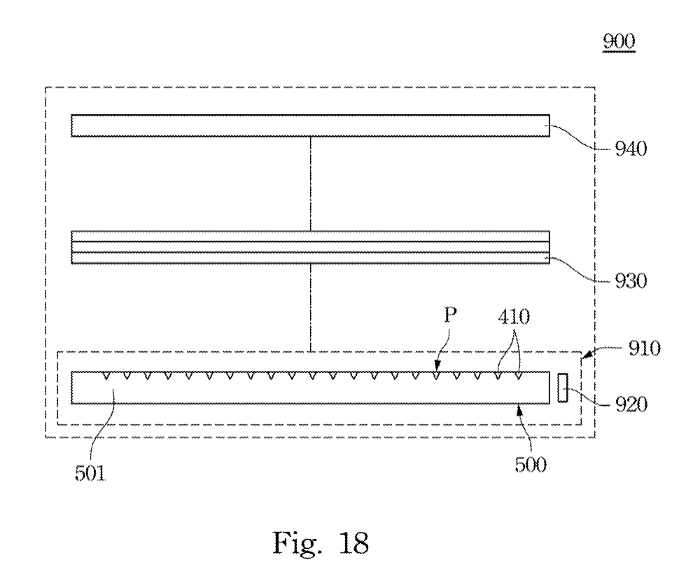

Referring to FIG. 18, which is a schematic view showing the display device 900 according to one embodiment of the present invention. The present invention further discloses a display device 900, which comprises a backlight module 910, at least an optical film 930 and a display panel 940. The backlight module 910 includes a light source 920 and the light guide plate 500 as the above mentioned. The light source 920 is installed at the side where the light incident surface of the plate member 501 is defined for enabling the light incident surface to receive lights of the light source 920. The light source 920 can be composed of one or a plurality of light emitting diodes. The optical film 930 is stacked on the optical microstructure pattern P of the light guide plate 500, and disposed between the backlight module 910 and the display panel 940.

Accordingly, because each protrusion 420 of the crater of the micro notch 410 has been downsized or smashed, and the height thereof can no longer be maintained, so the adhering degree of the optical microstructure pattern P of the light guide plate 500 and the optical film 930 can be enhanced, for increasing the flux of light inputting to the optical film 930 so as to keep a good light output efficiency, meanwhile the present invention can reduce the probabilities of the mentioned optical film 930 being scratched or pierced, so the optical film 930 is prevented from being damaged and the service life is therefore prolonged.

As what is mentioned above, the method of making an optical microstructure patterns on a light guide plate provided by the present invention does not need additional processing means to smash and eliminate the crater profile at each micro notch, and the laser used to form the micro notch to improve or eliminate the crater profile at each micro notch at the same stage in which the micro notch being formed, the crater profile at each micro notch can be improved or removed, so the processing step is not needed, so the processing cost and expenditure for acquiring the processing equipment are saved.

Moreover, according to still one another embodiment of the present invention, the substrate 400˜402 can also be an imprinting mold made of a metal material or a plastic material. Because the action theory of laser is to melt the surface of the imprinting mold with the power of laser, and with the cohesion and surface tension of the mold surface material, the location where the imprinting mold being bombarded by the laser forms a cone-shaped notch. As such, the imprinting mold can be served as a mold core for processing injection molding or thermal imprinting molding to make the light guide plate and the optical microstructure pattern on the light guide plate.

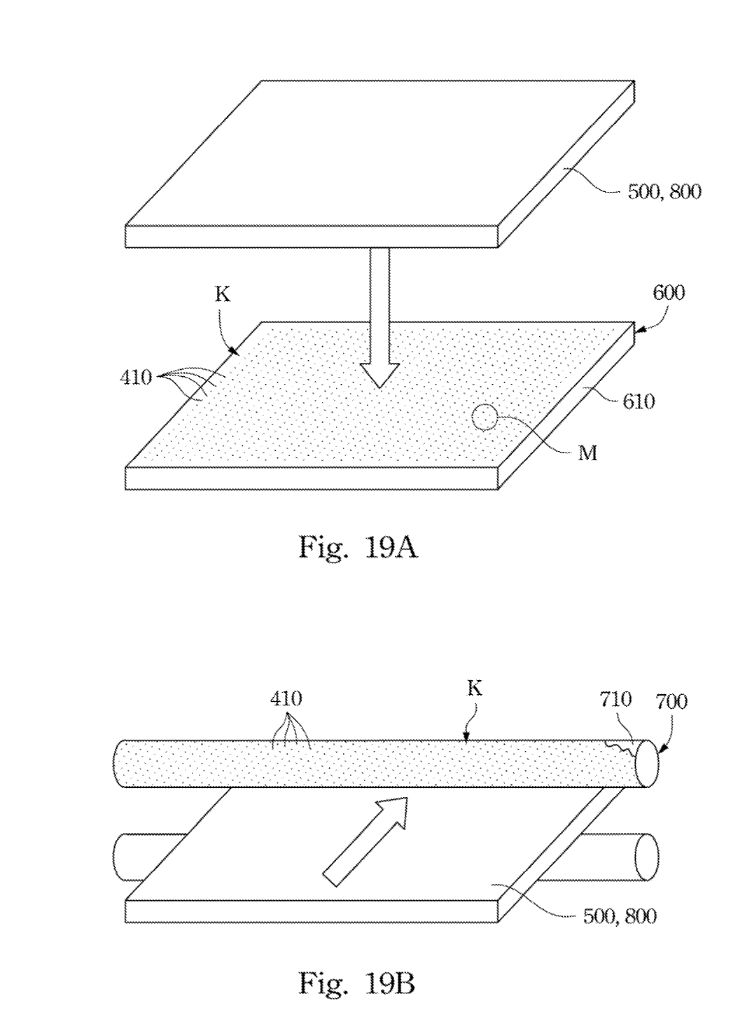

Referring to FIG. 19A, which is a schematic view showing the operation of one alterative of the imprinting mold for forming an optical microstructure pattern.

The imprinting mold is an imprinting template 600. The micro notches 410 are corresponding to the arrangement means of the mentioned optical microstructure pattern, and distributed on one surface of the imprinting template 600, for imprinting to a light guide plate 500 or a transfer plate 800.

Referring to FIG. 19B, which is a schematic view showing the operation of another alterative of the imprinting mold for forming an optical microstructure pattern. The imprinting mold is a roller 700. The micro notches 410 are corresponding to the arrangement means of the optical microstructures of the mentioned optical microstructure pattern, and distributed on one circumference 710 of the roller 700, and a transfer plate 800 is utilized to form a micro hole concentrated pattern K to imprint to a light guide plate 500 or a transfer plate 800.

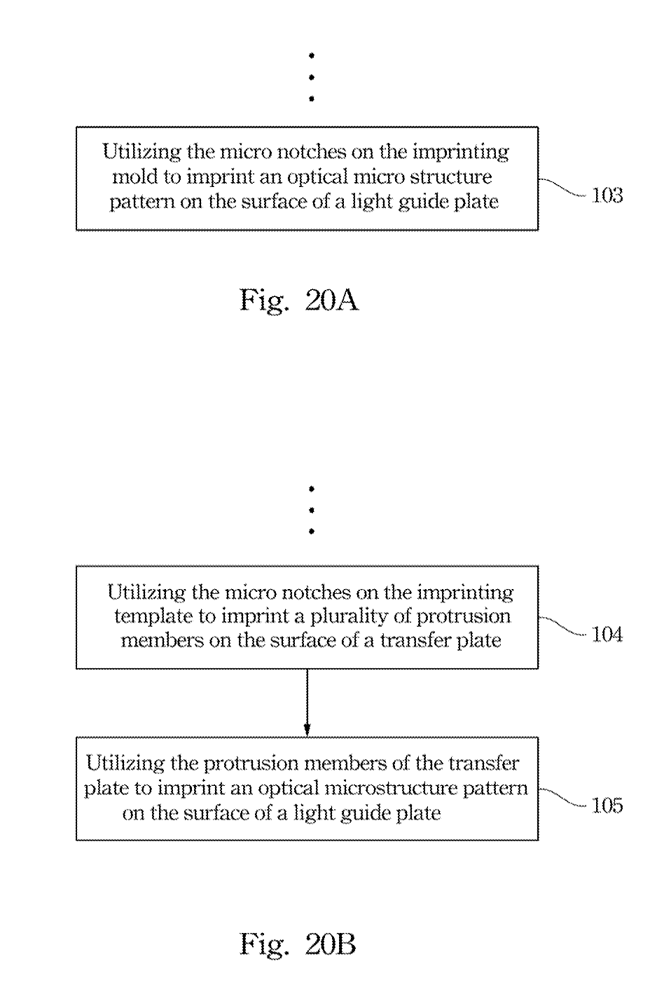

Referring to FIG. 19A, FIG. 19B or FIG. 20A, wherein FIG. 20A is a subsequent flow chart showing the method of making an optical microstructure pattern on a light guide 500, according to still one another embodiment of the present invention.

When the substrate 400˜402 is a imprinting mold, Step (102) of the method of making an optical microstructure pattern on the light guide plate 500 is further followed by:

Step (103): utilizing the micro notches 410 on the imprinting mold to imprint an optical microstructure pattern on the surface of a light guide plate 500. As such, the surface of the light guide plate 500 is formed with a plurality of protrusion members (not shown) having shapes complementary to the micro notches 410.

Referring to FIG. 20B, which is a subsequent flow chart showing the method of making an optical microstructure pattern on a light guide 500, according to still one another embodiment of the present invention. When the substrate 400˜402 is a imprinting mold, Step (102) of the method of making an optical microstructure pattern on the light guide plate 500 is further followed by:

Step (104): utilizing the micro notches 410 on the imprinting mold to form a plurality of protrusion members on the surface of a transfer plate 800, wherein each protrusion member has the shape complementary to the shape of the micro notch 410; and

Step (105): utilizing the protrusion members on the transfer plate 800 to imprint a plurality of optical microstructures on the surface of a light guide plate 500, wherein each optical microstructure has the same shape as the micro notch 410.

The arrangement means of the optical microstructures is not limited by the present invention, e.g. being uniformly or non-uniformly arranged, or being arranged in an array means or being linearly arranged. The research and development personnel can choose or adjust the arrangement means of the optical microstructure according to actual needs

Because each concave portion is formed through the bombarding of the second laser, the mentioned molten slag splashing phenomenon would inevitably happen, however, the bombarding degree of the second laser is much less than the bombarding degree of the first laser, so the contour of each concave portion having the crater is less obvious than the crater profile at each micro notch. As such, the mentioned disadvantages and inconvenience of the conventional arts are avoided. With proper adjustment, the concave portions generated by the second laser can be not provided with the crater profile. Referring to FIG. 19A, the imprinting mold 600 is made of a metal material or a plastic material, and includes a main body 610 and a micro hole concentrated pattern K. The micro hole concentrated pattern K is disposed on one working surface of the main body 610 to imprint an optical microstructure pattern on the surface of a light guide plate or an optical film/plate (e.g. a diffusion film or diffusion plate).

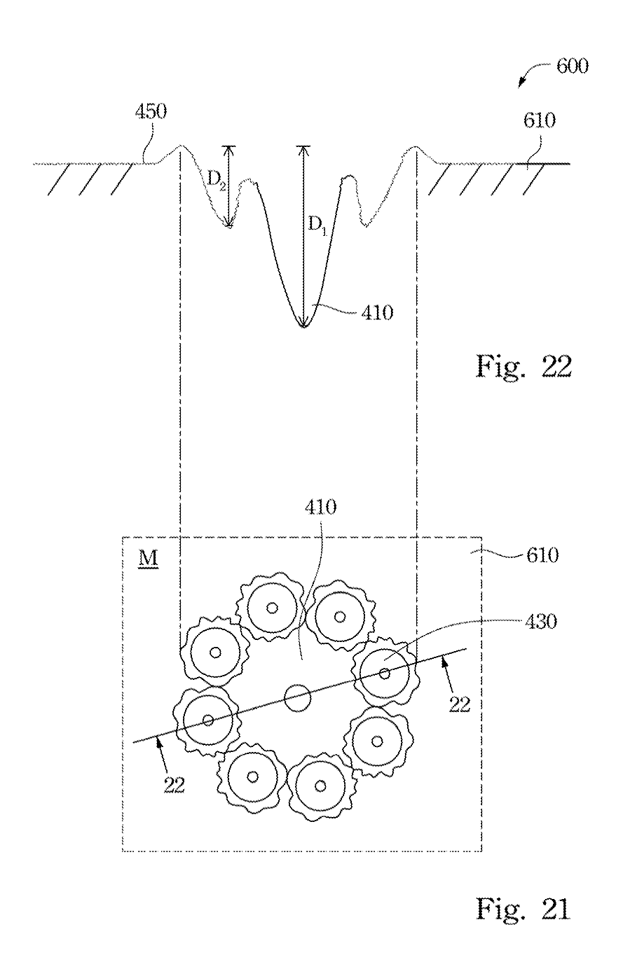

Referring to FIG. 21 and FIG. 22, wherein FIG. 21 is a top view showing one micro notch 410 in a zone M of the micro hole concentrated pattern K of the imprinting mold 600 according to one embodiment of the present invention; and FIG. 22 is a cross sectional view taken alone line 22-22 of FIG. 21.

The micro hole concentrated pattern K is composed of a plurality of micro notches 410 being arranged (as shown in FIG. 19A). The periphery of each micro notch 410 is distributed with one or a plurality of concave portions 430 recessed toward the main body 610 (as shown in FIG. 21), one or a plurality of downsized protrusions 421 (discloses hereinafter) or distributed with both.

As such, each protrusion 420 of the craters has been downsized or smashed, the original height thereof can no longer be maintained, so the probabilities of the imprinting mold 600 imprinting incorrect optical microstructure patterns on the light guide plate or the optical film/plate (e.g. the diffusion film or diffusion plate) can be greatly reduced, moreover, the service life of the imprinting mold 600 is prolonged.

According to the above mentioned, the concave portions 430 are also formed through being melted by laser 300 (FIG. 6(b)), so the surfaces of each concave portion 430 (including the inner surface and outer surface) all have molten surfaces 450 formed through the laser 300, and the depth D2 of each concave portion 430 is smaller than the depth D2 of the micro notch 410 (as shown in FIG. 22). The mentioned molten surface 450 is formed with burned marks (e.g. yellow or black in color). Substantially, the degree of burned marks is gradually changed from dark to light from the peripheries of the micro notches 410 (including the concave portions 430) toward a direction away from the micro notches 410. In other words, the molten surface 450 is gradually changed from dark to light in a ripple fashion from the periphery of the micro notch 410 toward a direction away from the micro notches 410.

The arrangement means of the optical microstructures is not limited by the present invention, e.g. being uniformly or non-uniformly arranged, or being arranged in an array means or being linearly arranged. The research and development personnel can choose or adjust the arrangement means of the optical microstructure according to actual needs.

The present invention further provides more embodiments for disclosing detail changes of the periphery of each micro structure 410.

Referring to FIG. 6, FIG. 21 and FIG. 22, according to one embodiment of the present invention, when the protrusions 420 of craters are bombarded, the laser generator 100 moves along a clock direction (e.g. clockwise direction or counterclockwise direction) of the periphery of each micro notch 410, and the laser 300 are utilized to bombard on the protrusions 420 at the periphery of the micro notch 410, so a plurality of non-continuous concave portions 430 are formed. The concave portions 430 are arranged separately at the periphery of the micro notch 410 and together surround the micro notch 410, and the concave portions 430 are not in communication with each other. Moreover, in this embodiment, the interiors of the concave portions 430 can be arranged to not be in communication with the micro notch 410 (as shown in FIG. 22), or can be arranged to be all in communication with the micro notch 410.

What shall be addressed is that each concave portion 430 is formed through the bombarding of the laser 300, so the width of each concave portion 430, the distance therebetween, and the depth D2 of recessing towards the main body 610 are not able to be completely the same. So the concave portions 430 shown in FIG. 4 and FIG. 5 are served as examples, and the contours of the concave portions 430 at the peripheries of all micro notches 410 are not limited to what are shown in FIG. 21 and FIG. 22.

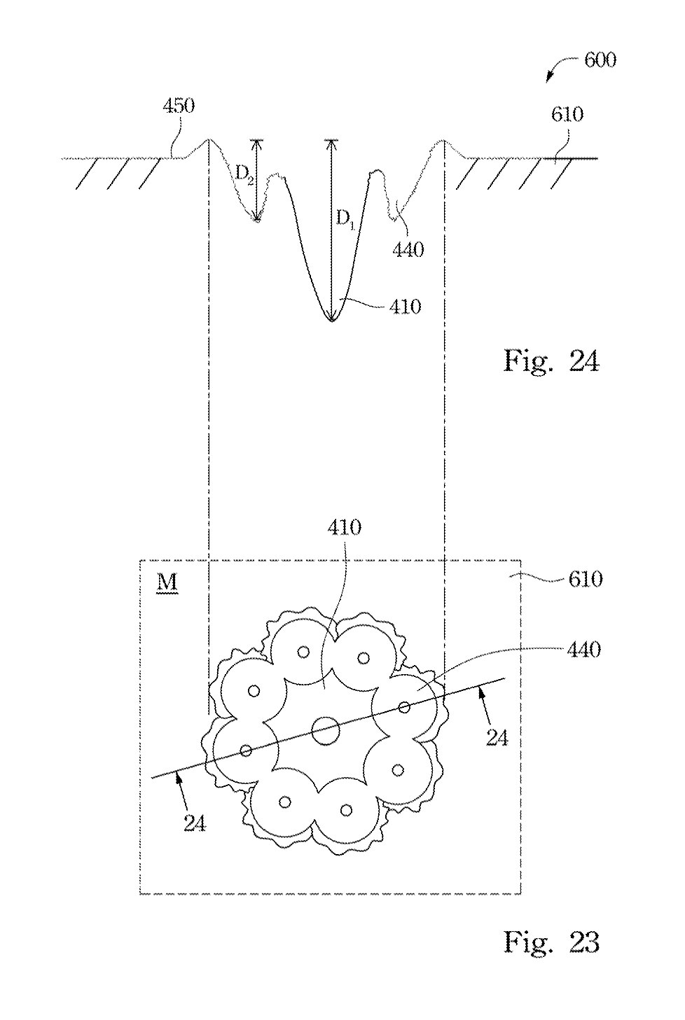

Referring to FIG. 6, FIG. 23 and FIG. 24, wherein FIG. 23 is a top view showing one micro notch 410 in a zone M of the micro hole concentrated pattern K of the imprinting mold 600 according to another embodiment of the present invention; and FIG. 24 is a cross sectional view taken alone line 24-24 of FIG. 23.

According to another embodiment of the present invention, when the protrusions 420 of the craters are bombarded (as shown in FIG. 6), the laser generator 100 utilizes the laser 300 to bombard each micro notch 410 and break the protrusions 420 at the periphery of the micro notch 410, an annular concave portion 440 recessed toward the main body 610 is formed at a location corresponding to the periphery of the micro notch 410, wherein the annular concave portion 440 surrounds the micro notch 410, and the depth D2 of the annular concave portion 440 is smaller than the depth D1 of the micro notch 410. Moreover, in this embodiment, the interiors of the concave portions can be arranged to not be in communication with the micro notch, or can be arranged to be all in communication with the micro notch 410 (as shown in FIG. 24).

What shall be addressed is that the annular concave portion 440 is formed through the bombarding of the laser 300, so the dimension of the annular concave portion 440, or the depth D2 recessing toward the main body 610 are not able to be completely the same. As such, the annular concave portion 440 shown in FIG. 23 and FIG. 24 is served as examples, and the contour of the annular concave portion 440 at the peripheries of all micro notches 410 is not limited to what are shown in FIG. 23 and FIG. 24.

After each concave portion 430 (or the annular concave portion 440) at the periphery of each micro notch 410 of the imprinting mold 600 is formed, there may be dusts, particles or debris remained on the imprinting mold 600, so when the interiors of the concave portions 430 (or the annular concave portions 440) are not in communication with the micro notch 410, each concave portion 430 (or the annular concave portion 440) can assist to collect the dusts, particles or debris for lowering the probabilities of falling into each micro notch 410.

What shall be addressed is that because the concave portion 430 (or the annular concave portion 440) is shallower than the micro notch 410, so even being filled with the dusts, particles or debris, the effect of the imprinting mold 600 forming the optical microstructure pattern on the light guide plate or the optical film/plate (e.g. the diffusion film or diffusion plate) is not affected.

Because each concave portion 430 (or the annular concave portion 440) is formed through the bombarding of the laser 300, the mentioned molten slag splashing phenomenon would inevitably happen, however, the bombarding degree of the laser 300 used to bombard the protrusions 420 is much less than the bombarding degree of the laser used for generating the micro notch 410, so the crater profile is less obvious than the crater profile at each micro notch 410. As such, the mentioned disadvantages and inconvenience of the conventional arts are avoided.

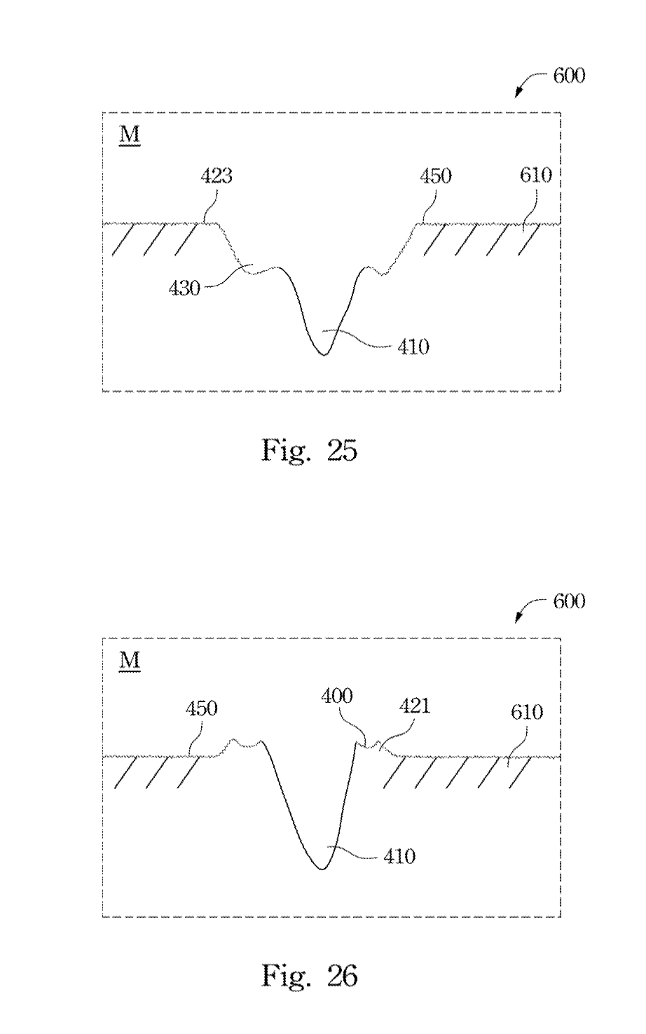

Referring to FIG. 6 and FIG. 25, wherein FIG. 25 is a top view showing one micro notch 410 in a zone M of the micro hole concentrated pattern K of the imprinting mold 600 according to still one another embodiment of the present invention.

According to the still one another embodiment of the present invention, when the protrusions 420 at the crater are bombarded (as shown in FIG. 6), through properly adjusting the parameter of the laser generator 100 (e.g. pulses of small power or small frequency), when the laser generator 100 enables the laser 300 to bombard each protrusion 420 at the periphery of the micro notch 410, the outer end of the concave portion 430 is prevented from forming the crater profile, i.e. the location where the surface of the main body 610 being connected to the outer end of the concave portion 430 is formed with a plane part 423 substantially aligned with the surface of the main body 610.

Because each micro notch 410 no longer has the crater profile, the situation that the protrusions 420 (as shown in FIG. 4) being bended or collapsed to fall in the micro notch 410 is avoided, thereby facilitating the light guide plate or the optical film/plate (e.g. the diffusion film or diffusion plate) to be imprinted with complete optical microstructure patterns.

Referring to FIG. 6 and FIG. 26, wherein FIG. 26 is a top view showing one micro notch 410 in a zone M of the micro hole concentrated pattern K of the imprinting mold 600 according to still one another embodiment of the present invention.

According to the still one another embodiment of the present invention, when the protrusions 420 at the crater are bombarded (as shown in FIG. 6), through properly adjusting the parameter of the laser generator 100 (e.g. pulses of small power or small frequency), when the laser generator 100 enables the laser 300 to bombard each protrusion 420 at the periphery of the micro notch 410, and after the protrusions 420 are broken and collapsed on the surface of the main body 610, only downsized protrusions 421 (as shown in FIG. 26) are formed, instead of the concave portions. The tops of the protrusions 421 all have molten surfaces 450 formed through being bombarded by laser. The molten surfaces 450 are e.g. burned marks (e.g. yellow or black in color). The degree of burned marks is gradually changed from dark to light from the peripheries of the micro notches 410 toward a direction away from the micro notches 410.

As such, the residual protrusions 421 can no longer maintain the height thereof, the probabilities of the protrusions 421 falling into the micro notches 410 due to being bended or clasped are reduced, thereby facilitating the light guide plate or the optical film/plate (e.g. the diffusion film or diffusion plate) to be printed with complete optical microstructure patterns.

What shall be addressed is that the downsized protrusions 421 are formed through the bombarding of the laser 300, so the dimension and the contour of the downsized protrusions 421 are not able to be completely the same. As such, the downsized protrusions 421 shown in FIG. 26 are served as examples, and the contours of all the downsized protrusions 421 are not limited to what are shown in FIG. 26.

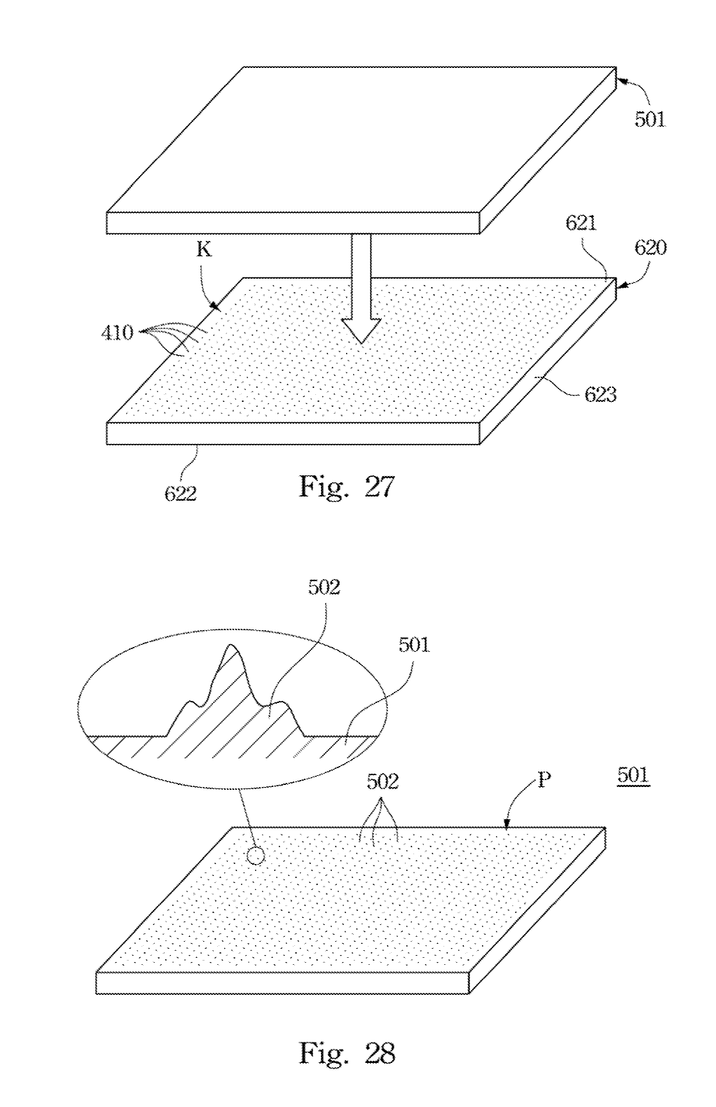

Referring to FIG. 27 and FIG. 28, wherein FIG. 27 is a schematic view showing the appearance and the operation of the imprinting mold 600 according to one embodiment of the present invention; FIG. 28 is a schematic view showing the imprinting mold 600 being utilized to imprint optical microstructure patterns P on a light guide plate 501 (serving as an example not a limitation) according to one embodiment of the present invention, also showing a partially enlarged view of one of the protrusion member 502.

In the imprinting mold 600 according to this embodiment of the present invention, the main body 610 is an imprinting template 620. The imprinting template 620 is substantially in a rectangular shape, and has a front surface 621 and an opposite rear surface 622, and a plurality of lateral surfaces 623 surrounding the front surface 621 and the rear surface 622. Each lateral surface 623 can be defined as the surface which can be referred as the thickness of the imprinting template 620, and the area of any of the lateral surfaces 623 is smaller than that of the front surface 621 and the rear surface 622. The working surface is defined on the front surface 621 or the rear surface 622 of the printing template 620, i.e. the micro hole concentrated pattern K is distributed on the front surface 621 or the rear surface 622 of the printing template 620 or on both of the front and rear surfaces 621, 622.

As such, when a user dispose and press a light guide plate 501, which is not yet solidified, on the micro hole concentrated pattern K on the surface of the printing template 620, the surface of the light guide plate 501 is printed with an optical microstructure pattern P (as shown in FIG. 28). So the surface of the light guide plate 501 is formed with a plurality of protrusion members 502, and the protrusion members 502 and the micro notches 410 and the concave portions have mated shapes.

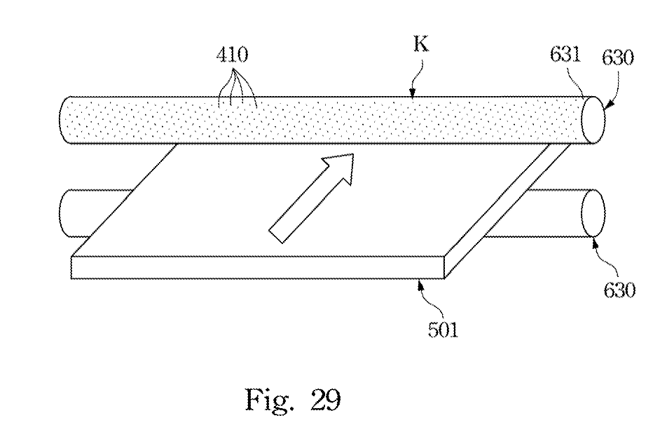

Referring to FIG. 28 and FIG. 29, wherein FIG. 29 is a schematic view showing the appearance and the operation of the imprinting mold 600 according to another embodiment of the present invention.

In the imprinting mold 600 according to this embodiment of the present invention, the main body 610 is a roller 630. The working surface is defined on the circumference 631 of the roller 630, i.e. the micro hole concentrated pattern K is distributed on the circumference 631 of the roller 630.

As such, when a light guide plate 501, which is not yet solidified, passes through a gap between two rollers 630, wherein the circumference 631 of at least one roller 630 has the micro hole concentrated pattern K so the surface of the light guide plate 501 is imprinted with an optical microstructure pattern P (as shown in FIG. 28). So the surface of the light guide plate 501 is formed with a plurality of protrusion members 502, and each protrusion member 502 and one micro notch 410 and the concave portions at the periphery of the micro notch 410 have mated shapes.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of making optical microstructure pattern on light guide plate, comprising:
utilizing a first laser to bombard a surface of a substrate, such that a micro notch is formed on the surface of the substrate, wherein the periphery of the micro notch is formed with at least one protrusion; and
utilizing at least a second laser to bombard the protrusion for at least downsizing the dimension of the protrusion.

2. The method of making optical microstructure pattern on light guide plate according to claim 1, wherein a power of the first laser is the same as a power of the second laser, and the pulse number of the second laser is smaller than that of the first laser.

3. The method of making optical microstructure pattern on light guide plate according to claim 1, wherein a power of the second laser is smaller than a power of the first laser.

4. The method of making optical microstructure pattern on light guide plate according to claim 3, wherein a pulse number of the second laser is smaller than a pulse number of the first laser.

5. The method of making optical microstructure pattern on light guide plate according to claim 3, wherein a pulse number of the second laser is the same as a pulse number of the first laser.

6. The method of making optical microstructure pattern on light guide plate according to claim 1, wherein a power of the second laser is greater than a power of the first laser, and a pulse number of the second laser is smaller than a pulse number of the first laser.

7. The method of making optical microstructure pattern on light guide plate according to claim 6, wherein utilizing the second laser to bombard the protrusion further comprises:
according to a coordinate where the first laser bombarding the surface of the substrate, the second laser aiming at and bombarding the micro notch, so as to damage the at least one protrusion and form an annular concave portion on the periphery of the micro notch,
wherein the annular concave portion surrounds the micro notch, and the depth of the annular concave portion is lesser than the depth of the micro notch.

8. The method of making optical microstructure pattern on light guide plate according to claim 1, wherein when the periphery of the micro notch is formed with a plurality of the protrusions, utilizing the second laser to bombard the protrusion further comprises:
bombarding the protrusions at the periphery of the micro notch, along a clock direction of the periphery of the micro notch, for damaging the protrusions to respectively form a plurality of concave portions on the periphery of the micro notch,
wherein a depth of each concave portion is lesser than a depth of the micro notch.

9. The method of making optical microstructure pattern on light guide plate according to claim 1, wherein when the periphery of the micro notch is formed with a plurality of the protrusions, utilizing the second laser to bombard the protrusion further comprises:
bombarding the protrusions at the periphery of the micro notch with an overlapped means, along a clock direction of the periphery of the micro notch, for damaging the protrusions to form an annular concave portion on the periphery of the micro notch,
wherein the annular concave portion surrounds the micro notch and the depth of the annular concave portion is smaller than the depth of the micro notch.

10. The method of making optical microstructure pattern on light guide plate according to claim 1, wherein the substrate is a imprinting mold, and the method of making optical microstructure pattern further comprises:
utilizing the imprinting mold to imprint a plurality of protrusion members on a surface of a transfer plate, wherein each protrusion member is complementary to the micro notch in shape; and
utilizing the transfer plate to imprint a plurality of optical microstructures on a surface of a light guide plate, wherein each optical microstructure is the same as the micro notch in shape.

11. A method of making optical microstructure pattern on light guide plate, comprising:
according to a coordinate on a surface of a substrate, a first laser is utilized to bombard a surface of the substrate, such that a micro notch is formed on the surface of the substrate; and
according to the same coordinate, a second laser is utilized to bombard the micro notch again, such that a width of the micro notch is enlarged, wherein a power of the second laser is greater than a power of the first laser, and a pulse number of the second laser is smaller than a pulse number of the first laser.

12. The method of making optical microstructure pattern on light guide plate according to claim 11, wherein before utilizing the second laser to bombard the periphery of the micro notch, further comprises:
processing several times of utilizing the first laser to bombard the surface of the substrate, such that a plurality of the micro notches are distributed on the surface of the substrate.

13. A light guide plate, comprising:
a plate member; and
an optical microstructure pattern, distributed on a surface of the plate member, and comprising a plurality of micro notches,
wherein the periphery of each micro notch is with at least one concave portion, the concave portion has a molten surface, and a depth of each concave portion is smaller than a depth of the micro notch.

14. The light guide plate according to claim 13, wherein a plurality of the concave portions are in communication with each other so as to form an annular concave portion.

15. The light guide plate according to claim 13, wherein a plurality of the concave portions are not in communication with each other and are arranged separately.

16. The light guide plate according to claim 13, wherein the molten surface is presented as burned marks formed through a laser process by laser.
